(19) United States
(12) Patent Application Publication
(10) Pub. No.: US 2024/0189859 A1
(43) Pub. Date: Jun. 13, 2024

(54) INK-FILLED CARTRIDGE

(71) Applicant: TAIYO HOLDINGS CO., LTD., Saitama-ken (JP)

(72) Inventors: Kousuke NAKAJIMA, Saitama-ken (JP); Chika TAKAHASHI, Saitama-ken (JP); Yasuyo KANAZAWA, Saitama-ken (JP); Tomotaka NOGUCHI, Saitama-ken (JP)

(73) Assignee: TAIYO HOLDINGS CO., LTD., Saitama-ken (JP)

(21) Appl. No.: 18/284,908

(22) PCT Filed: Mar. 29, 2022
(86) PCT No.: PCT/JP2022/015422

§ 371 Date: Sep. 29, 2023

(30) Foreign Application Priority Data
Mar. 29, 2021 (JP) 2021-056109

(51) Int. Cl. B05C 17/005; B65D 41/00; B65D 83/00

(52) U.S. Cl. CPC B05C 17/00593; B65D 41/005; B65D 83/0022

(57) ABSTRACT

An ink-filled cartridge includes a cartridge, including a cylindrical syringe and a plunger, and an ink therein. The ink has a viscosity at 25° C. of from 50 to 2,000 dPa·s. The ink contains one or more air bubbles having a diameter of 0.1 mm or more. A total volume A of air bubbles in a portion of the syringe corresponding to a distance from a lower end of a discharge nozzle of the cylindrical syringe to a mid-point between the lower end and the plunger, and a total volume B of air bubbles in a portion of the syringe corresponding to a distance from the mid-point to the plunger, satisfy: 0≤A/B<1.0.

### BACKGROUND OF THE INVENTION

### Field of the Invention

The present invention relates to an ink-filled cartridge.

### Background Art

As electronic devices have a smaller size and higher function, printed wiring boards are required to have a finer pattern, a smaller footprint, and a higher component mounting density. Therefore, a double-sided substrate provided with open holes for forming interlayer connection that electrically connects between different wiring layers, namely, through holes, or a multilayer substrate such as a build-up circuit board in which insulating layers and conductor circuits are formed sequentially on a core material, and interlayer connection is established through via holes and the like to be formed into a multilayer structure, is used.

In such a printed wiring board, there are cases where recesses between the conductor circuits on the surface of the printed wiring board, or holes such as through holes and via holes on the inner wall surfaces of which wiring layers are formed, are subjected to a hole filling processing with a curable resin filler. Such a hole filling processing is performed by filling a filling ink composed of a curable resin filler into the holes or recesses, and curing the ink. The filling of holes with an ink is sometimes performed by discharging a specified amount of ink from an ink cartridge, using a coating apparatus such as a dispenser.

In the case of discharging the ink using the ink cartridge as described above, and if air bubbles are mixed in the ink filled in the syringe of the cartridge, there are cases where the ink may be discharged intermittently at the time of being discharged or the discharged amount of the ink may vary, possibly resulting in the occurrence of a problem in a wiring substrate which has been subjected to the hole filling processing. Therefore, it can be said that it is desired that no air bubbles be mixed in the ink filled in the ink cartridge. Accordingly, a degassing treatment by vacuum degassing or centrifugation is usually performed, when filling the ink into the ink cartridge. However, since an ink such as the curable resin filler described above generally has a high viscosity, due to containing a large amount of a resin component and a filler component, it is difficult to completely remove a very small amount of air bubbles contained in the ink by the above-described degassing treatment.

To address the problem as described above, for example, Patent Document 1 discloses a syringe filled with a resin composition, in which the mixing of voids (air bubbles) is reduced, in which the proportion of voids in the resin composition filled in the syringe is from 1.0 volume ppm to 520 volume ppm, and in which the maximum diameter of the voids is 2,500 μm or less.

### CITATION LIST

### Patent Document

Patent Document 1: JP 2020-127919 A

### SUMMARY OF THE INVENTION

### Technical Problem

In general, the above-described ink composed of a curable resin filler is stored frozen so that the curing reaction of the resin does not proceed within the syringe, before use. Therefore, even if the amount of air bubbles mixed in the ink during the storage is extremely small, the volume of the air bubbles increases as the temperature of the ink changes when the ink is thawed for use. Accordingly, there have been cases where the ink is discharged intermittently from the syringe at the time of using the ink, even in the case of a syringe filled with a resin composition as one disclosed in Patent Document 1.

The present invention has been made in order to solve such a problem, and an object of the present invention is to provide an ink-filled cartridge in which a smaller amount of air bubbles is mixed, and in which the intermittent discharge of the ink can be reduced.

### Solution to Problem

It is considered that the intermittent discharge of the ink cannot be completely prevented, only by reducing the amount of air bubbles inevitably mixed into the ink during the filling of the ink into the syringe. The present inventors focused on the positions of the air bubbles contained in the ink filled in the syringe, and arrived at an idea that, even when a very small amount of air bubbles is mixed into the ink, the intermittent discharge of the ink upon use can be reduced, if the air bubbles are localized at a predetermined position in the syringe. The present invention has been made based on such a finding.

Specifically, the gist of the present invention is as follows.

[1] An ink-filled cartridge comprising:
a cartridge comprising:
   a cylindrical syringe having a discharge nozzle on one end and having an opening on the other end; and
   a plunger configured to slide from the opening of the syringe to define the filling capacity within the syringe; and
an ink filled in the defined space within the syringe of the cartridge;
wherein the ink has a viscosity at 25° C. of from 50 to 2,000 dPa·s, as measured in accordance with “10. Viscosity Measurement Method Using Cone-plate Rotational Viscometer” specified in JIS K 8803: 2011, using a cone-plate viscometer at 25° C. and 5 rpm for 30 seconds;
the ink in the syringe contains at least one or more air bubbles having a diameter of 0.1 mm or more; and
when the distance from the lower end of the discharge nozzle to the plunger, in the cylindrical axis direction of the syringe, is defined as L, and when the lower end of the discharge nozzle is defined as a starting point (S), a point at a distance of L/2 therefrom is defined as a point (M) and the plunger is defined as an end point (F), the total volume A (cm³) of air bubbles in the portion of the syringe corresponding to the distance from the starting point (S) to the point (M), and the total volume B (cm³) of air bubbles in the portion of the syringe corresponding to the distance from the point (M) to the end point (F), satisfy the following relation:

0≤A/B<1.0.

[2] The ink-filled cartridge according to [1], wherein the total volume A′ (cm³) of air bubbles in the portion of the syringe corresponding to the distance from the starting point (S) to a point (M′) at a distance of 0.9 L therefrom, in the cylindrical axis direction of the syringe, and the total volume B′ (cm³) of air bubbles in the portion of the syringe corresponding to the distance from the point (M′) to the end point (F), in the cylindrical axis direction, satisfy the following relation:

0≤A′/B′<1.0.

[3] The ink-filled cartridge according to [2], wherein the air bubbles present in the portion of the syringe corresponding to the distance from the starting point (S) to the point (M′) have a diameter of from 0.3 mm or less.

[4] The ink-filled cartridge according to [1], wherein, when the volume of the ink filled in the portion of the syringe corresponding to the distance from the point (M) to the end point (F) is defined as C (cm³), the ratio of the total volume B of air bubbles with respect to the volume C of the ink satisfies the following relation:

0≤B/C≤1.0×10⁻¹.

[5] The ink-filled cartridge according to [1] or [2], wherein the ink-filled cartridge is stored in an environment in which the temperature of the filled ink reaches 10° C. or lower.

[6] The ink-filled cartridge according to [1] or [2], wherein the ink includes at least a thermosetting resin, a curing agent and a filler.

[7] The ink-filled cartridge according to [1] or [2], wherein the ink is a filling ink for filling a hole in a printed wiring board.

[8] The ink-filled cartridge according to [1] or [2], wherein the ink-filled cartridge includes a tip cap on the upper end of the discharge nozzle.

[9] A method of using the ink-filled cartridge according to [1] or [2], the method including, at the time of using the ink-filled cartridge which has been stored in an environment of 10° C. or lower in a room temperature environment, maintaining the cartridge such that the discharge nozzle side thereof faces downward and the plunger side thereof faces upward, until the temperature of the ink reaches room temperature from 10° C. or lower.

### Effects of Invention

The ink-filled cartridge according to the present invention enables an ink-filled cartridge in which the intermittent discharge of the ink can be reduced, even in cases where the ink has a high viscosity and air bubbles in the ink cannot be completely removed. Therefore, the use of the ink-filled cartridge according to the present invention enables a high-quality circuit board to be produced without causing a problem in the hole filling processing, even in the case of using a filling ink for filling a hole in a printed wiring board which has a relatively high viscosity.

### BRIEF DESCRIPTION OF THE DRAWINGS

FIG. 1 is a cross-sectional view of an ink-filled cartridge according to one embodiment of the present invention.

FIG. 2 is a cross-sectional view of an ink-filled cartridge according to another embodiment of the present invention.

FIG. 3 shows cross-sectional views illustrating the filling operation of the ink to the cartridge.

FIG. 4 shows cross-sectional views taken along the lines E-E′ and F-F′ in the cartridge shown in FIG. 3.

FIG. 5 is a cross-sectional view of the ink-filled cartridge which has been subjected to a degassing treatment after the completion of the filling of the ink.

FIG. 6 shows cross-sectional views taken along the lines G-G′ and H-H′ in the cartridge shown in FIG. 5.

FIG. 7 is a schematic diagram illustrating the process of rotating and revolving the cartridge.

### DETAILED DESCRIPTION OF THE INVENTION

One embodiment of the present invention will be described below with reference to drawings. It is noted that, in the drawings attached to the present specification, the scales, aspect ratios and the like are modified from those of actual products and exaggerated, as appropriate, for the convenience of illustration and ease of understanding.

The terms such as “end”, “starting point” and “end point”, the values of length and angle and the like, which are used in the present specification for specifying shapes and geometric conditions as well as the degrees thereof, shall be interpreted to include the extent to which similar functions can be expected, without being bound by strict meanings.

Further, in the present invention, the “viscosity” refers to a viscosity as measured in accordance with “10. Viscosity Measurement Method Using Cone-plate Rotational Viscometer” specified in JIS Z 8803: 2011, and specifically refers to a value as measured using a cone-plate viscometer (TVE-33H, manufactured by Toki Sangyo Co., Ltd.) under the conditions of 25° C., 5 rpm and 30 seconds.

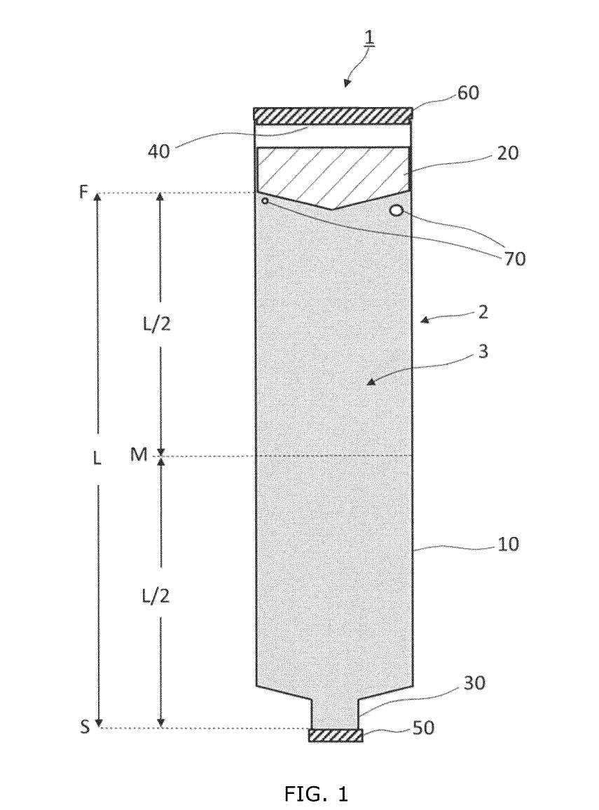

FIG. 1 is a cross-sectional view of an ink-filled cartridge according to one embodiment of the present invention. An ink-filled cartridge 1 is one in which an ink 3 is filled in a cartridge 2. As shown in FIG. 1, the cartridge 2 includes a syringe 10 and a plunger 20. The syringe 10 has a discharge nozzle 30 on one end, and has an opening 40 on the other end. The syringe 10 has a cylindrical shape, and the plunger 20 is configured to slide along the inner wall of the syringe 10 from the opening 40 of the syringe 10, to define the filling capacity within the syringe 10. At the time of using the ink-filled cartridge 1, the plunger 20 can be slid within the syringe to the side of the discharge nozzle 30, so that the ink 3 in the syringe 10 can be discharged from the discharge nozzle 30.

The end of the syringe on the side of the discharge nozzle 30 may have a conical shape, as shown in FIG. 1, so that the ink can be fully used without remaining in the cartridge, at the time of using the cartridge. In cases where the end of the syringe has a conical shape, the end of the plunger 20 on one end preferably has a conical shape.

According to the embodiment of the present invention, the cartridge 2 may include a tip cap 50 on the upper end of the discharge nozzle 30. By closing the opening of the discharge nozzle 30 with the tip cap 50, it is possible to prevent the leaking of the ink 3 filled in the syringe 10 from the upper end (discharge outlet) of the discharge nozzle 30. The discharge nozzle 30 can be sealed with the tip cap 50 by a known method, such as a method using a screw type or a snap type cap.

The opening 40 of the syringe 10 is preferably opened to the extent that a fixture (not shown) for sliding the plunger 20 can be inserted therethrough, rather than being fully open. In this case, a fringe (not shown) having an opening of a predetermined size at the central portion thereof may be provided at the end of the syringe 10. Further, a head cap 60 may be provided at the upper end of the syringe 10 so as to prevent the ink 3 filled in the syringe 10 from leaking. The head cap 60 closes the opening 40 of the syringe. Since the tip cap 50 and the head cap 60 need to be removed at the time of using the ink-filled cartridge 1, it is preferred that the tip cap 50 and the head cap 60 be detachably provided to the syringe 10. The syringe can be sealed with the tip cap 50 and the head cap 60 detachably by a known method, such as a method using a screw type or a snap type cap.

As described above, the ink-filled cartridge 1 is one in which the ink 3 is filled in the syringe 10 of the cartridge 2. At least one or more air bubbles 70 having a diameter of 0.1 mm or more are contained in the ink 3, and the air bubbles as a whole are localized in the ink 3. In other words, when the distance from the lower end of the discharge nozzle 30 to the plunger 20, in the cylindrical axis direction of the syringe 10, is defined as L, and when the lower end of the discharge nozzle 30 is defined as the starting point (S), a point at a distance of L/2 from the starting point (S) is defined as the point (M) and the plunger is defined as the end point (F), the total volume A (cm³) of air bubbles in the portion of the syringe corresponding to the distance from the starting point (S) to the point (M), and the total volume B (cm³) of air bubbles in the portion of the syringe corresponding to the distance from the point (M) to the end point (F), satisfy the following relation:

0≤A/B<1.0.

Since the air bubbles 70 contained in the ink 3 in the cartridge 2 are localized so as to satisfy the above-described relation, in the ink-filled cartridge according to the present invention, it is possible to reduce the occurrence of discharge defects, such as the intermitted discharge of the ink due to the presence of air bubbles, when the ink is discharged from the ink-filled cartridge using a dispenser apparatus or the like. Therefore, the use of the ink-filled cartridge according to the present invention enables a high-quality circuit board to be produced without causing a problem in the hole filling processing, even in the case of using a filling ink for filling a hole in a printed wiring board which has a relatively high viscosity. From the viewpoint of the effect of the present invention, the total volumes A and B preferably satisfy the relation: 0≤A/B<7.0×10⁻¹, and more preferably satisfy the relation: 0≤A/B<5.0×10⁻¹.

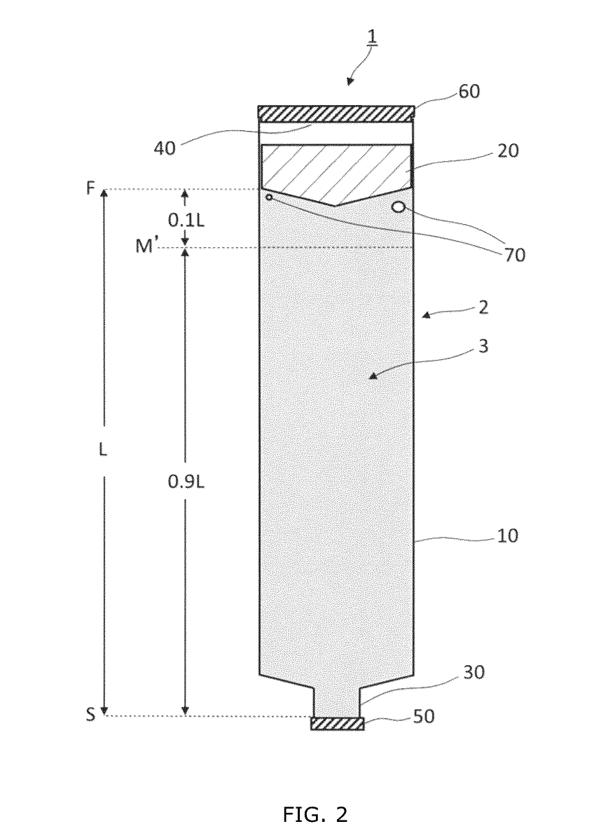

In a preferred embodiment of the ink-filled cartridge according to the present invention, as shown in FIG. 2, the total volume A′ (cm³) of air bubbles in the portion of the syringe corresponding to the distance from the starting point (S) to a point (M′) at a distance of 0.9 L therefrom, in the cylindrical axis direction of the syringe 10, and the total volume B′ (cm³) of air bubbles in the portion of the syringe corresponding to the distance from the point (M′) to the end point (F), in the cylindrical axis direction, satisfy the following relation:

0≤A′/B′<1.0.

When the ink is filled in the syringe so as to satisfy the above-described relation, the occurrence of discharge defects can further be reduced. From the viewpoint of the effect of the present invention, the total volumes A′ and B′ preferably satisfy the relation: 0≤A′/B′<7.0×10⁻¹, and more preferably satisfy the relation: 0≤A′/B′<5.0×10⁻¹.

Further, it can be said that the size of one air bubble is preferably the smaller the better. As will be described later in detail, however, air bubbles are inevitably mixed into the ink in cases where an ink having a high viscosity, such as one having a viscosity at 25° C. of from 50 to 2,000 dPa·s, is filled into the cartridge, and the air bubbles cannot be completely removed from the ink even if a degassing treatment by vacuum degassing or centrifugation is performed. The present invention aims to reduce the intermittent discharge of the ink at the time of using the ink-filled cartridge, by accumulating the air bubbles in the ink which are inevitably incorporated during the filling of the ink into the cartridge, to be formed into larger air bubbles having a certain size (diameter of 0.1 mm or more), and by localizing the air bubbles in the syringe of the cartridge. While at least one or more air bubbles having a diameter of 0.1 mm or more are contained in the ink in the syringe of the cartridge, it is needless to say that the inclusion of small air bubbles having a diameter of less than 0.1 mm is not excluded. Further, extremely small air bubbles having a diameter of about 0.3 mm or less do not substantially affect the discharge performance of the ink.

In one embodiment of the present invention, when the volume of the ink filled in the portion of the syringe corresponding to the distance from the starting point (S) to the point (M), in the cartridge 2, is defined as D (cm³), the ratio of the total volume A of air bubbles with respect to the volume D of the ink preferably satisfies the following relation:

0≤A/D≤1.0×10⁻²,

more preferably satisfies the relation: 0≤A/D≤1.0×10⁻³, and still more preferably satisfies the relation: 0≤A/D≤1.0×10⁻⁴.

Further, when the volume of the ink filled in the portion of the syringe corresponding to the distance from the starting point (S) to the point (M′) is defined as D′ (cm³), the ratio of the total volume A′ of air bubbles with respect to the volume D′ of the ink more preferably satisfies the following relation:

0≤A′/D′≤5.0×10⁻³,

particularly preferably satisfies the relation: 0≤A′/D′≤5.0×10⁻⁴, and particularly more preferably satisfies the relation: 0≤A′/D′≤5.0×10⁻⁵. If a smaller volume of air bubbles is contained in the ink in the portion thereof on the side closer to the discharge nozzle of the cartridge, the intermittent discharge of the ink can further be reduced.

In one embodiment of the present invention, when the volume of the ink filled in the portion of the syringe corresponding to the distance from the point (M) to the end point (F), in the cartridge 2, is defined as C (cm³), the ratio of the total volume B of air bubbles with respect to the volume C of the ink preferably satisfies the following relation:

0≤B/C≤1.0×10⁻¹,

more preferably satisfies the relation: 0≤B/C≤1.0×10⁻², and still more preferably satisfies the relation: 0≤B/C≤1.0×10⁻³.

Further, when the volume of the ink filled in the portion of the syringe corresponding to the distance from the point (M′) to the end point (F) is defined as C′ (cm³), the ratio of the total volume B′ of air bubbles with respect to the volume C′ of the ink preferably satisfies the following relation:

0≤B′/C′≤5.0×10⁻¹ more preferably satisfies the relation: 0≤B′/C′≤5.0×10⁻², and still more preferably satisfies the relation: 0≤B′/C′≤5.0×10⁻³. When the localized air bubbles are contained in the ink in such a degree that satisfies the above-described relation, the intermittent discharge of the ink can further be reduced.

The volume of air bubbles present in the ink filled in the cartridge can be measured using an industrial X-ray CT apparatus (for example, NAOMI-CT 3D-L (trade name), manufactured by RF Co., Ltd.). The measurement can be performed by the following method. Specifically, the entire interior of the syringe is subjected to 3D scanning using the industrial X-ray CT apparatus, for example, at a scanning resolution of 0.083 mm. Thereafter, while observing the vertical cross sections of the resulting 3D scanned image relative to the axial direction of the cylindrical syringe, continuously in the axial direction, the number of the respective air bubbles observed is counted, the maximum diameter (R) of each air bubble is measured, and the volume (V) of air bubble portion can be calculated from the thus measured maximum diameter, using the following Formula. In the following Formula, V represents the air bubble volume, and R represents the maximum diameter of air bubble.

V=(πR³)/6

Further, the total volume of air bubbles in the ink filled in the syringe can be calculated by summing the volume of each air bubble measured using the industrial X-ray CT apparatus. The volume of the ink can be calculated by measuring the specific gravity and the weight of the ink, and converting the measured values to volume.

The capacity of the syringe is not particularly limited, and the capacity can be adjusted as appropriate depending on the application to be used. However, the capacity of the syringe is preferably from 100 to 1,000 cm³, more preferably from 200 to 800 cm³, and still more preferably from 300 to 600 cm³, from the viewpoint of handleability. Further, the inner diameter of the syringe is preferably from about 2 to 6 cm, and the length of the syringe is from about 10 to 40 cm.

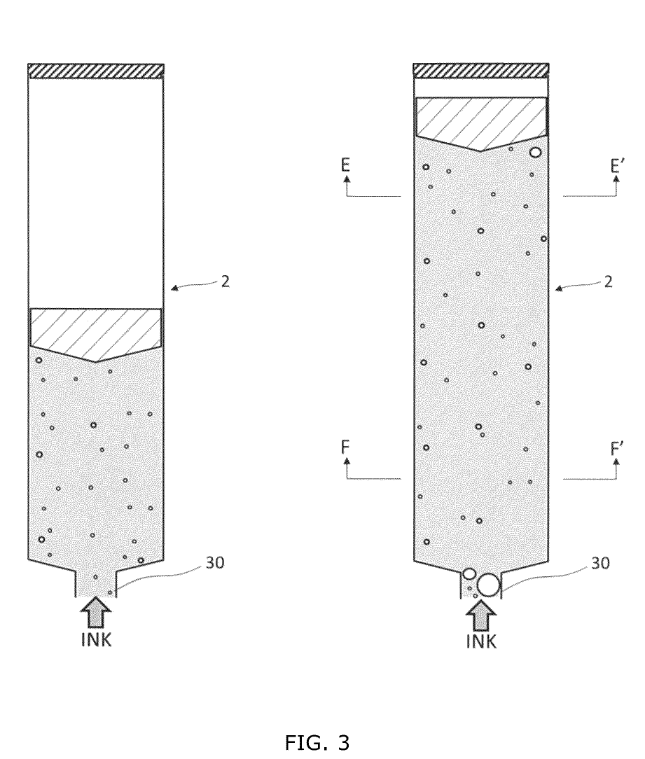

The ink to be filled into the cartridge is subjected to a degassing treatment by an ordinary method, during the preparation thereof. However, even in cases where air bubbles are hardly contained in the prepared ink, air bubbles are inevitably mixed into the ink during the filling of the ink into the cartridge, if the ink has a high viscosity. FIG. 3 shows cross-sectional views illustrating the filling operation of the ink to the cartridge. As shown in FIG. 3, the ink is filled from the side of the cartridge 2 on the discharge nozzle 30, and the plunger slides to the upper end side (the side provided with the opening) of the syringe, as the filling of the ink proceeds (shown on the left side of FIG. 3). In cases where the ink is a liquid having a high viscosity, the ink is filled into the syringe of the cartridge while entraining air during the filling. Therefore, fine air bubbles (having a diameter of from about 1 to 5 mm) are uniformly contained in the ink in a state where the filling of the ink has been completed (shown on the right side of FIG. 3). Such a very small amount of air bubbles cannot be moved upward (toward the side of the plunger in FIG. 3) only by gravity. While not shown, it is also possible to close the opening at the discharge nozzle 30 in advance and to fill the ink from the opening side of the syringe, before the plunger is inserted into the syringe. Even in this case, however, air bubbles are inevitably mixed into the ink in the same manner as described above, if the ink is a liquid having a high viscosity. Further, in the case of filling the ink from the opening side of the syringe, air bubbles are inevitably mixed not only in the vicinity of the opening, but also in the vicinity of the discharge nozzle.

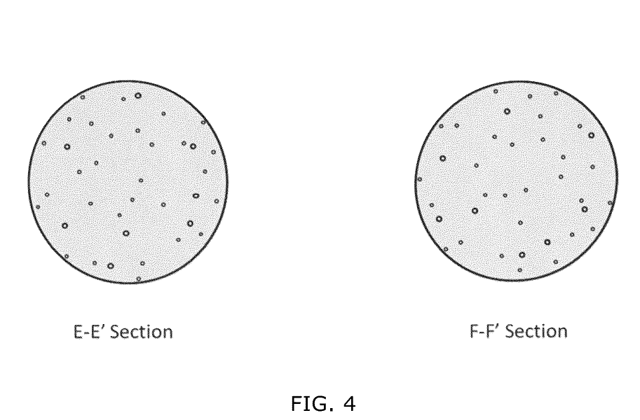

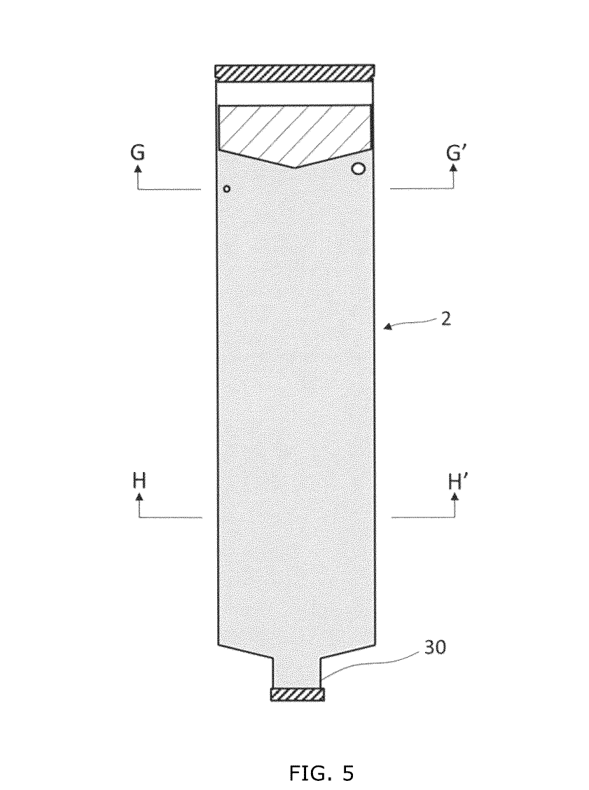

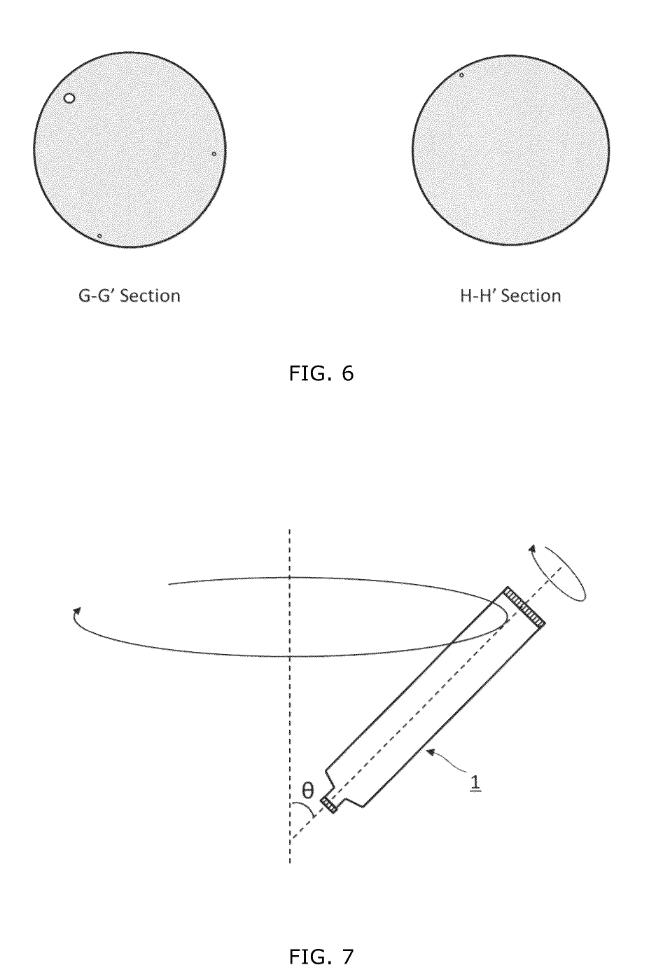

FIG. 4 shows the E-E′ cross section and the F-F′ cross section of the cartridge shown in FIG. 3. Further, FIG. 5 is a cross-sectional view in the cylindrical axis direction, of the ink-filled cartridge which has been subjected to a degassing treatment after the completion of the filling of the ink, and FIG. 6 shows the G-G′ cross section and the H-H′ cross section thereof In both of the cross section during the filling of the ink (left side of FIG. 4) and the cross section upon completion of the filling of the ink (right side of FIG. 4), fine air bubbles are contained in the ink without being localized. In contrast, in the ink-filled cartridge according to the present invention, the ink is filled so as to satisfy the relation: 0≤A/B<1.0, preferably satisfy the relation: 0≤A′/B′<1.0. Therefore, as shown in FIG. 5, the portion of the ink closer to the side of the discharge nozzle 30 does not contain air bubbles having a size which could affect the discharging of the ink, and air bubbles adjusted to a certain size (having a diameter of 0.1 mm or more) are localized on the side closer to the plunger. The air bubbles are preferably localized not only in the cylindrical axis direction of the syringe, but also localized in the cylindrical cross-sectional direction thereof. In this case, the air bubbles are preferably present in the vicinity of the inner wall of the syringe.

As the syringe included in the cartridge, it is possible to use a syringe made of any of various resins, such as polypropylene, polyethylene, polystyrene and polyester. As will be described later, the ink is preferably stored at a temperature of 10° C. or lower, particularly, stored frozen at a temperature of 0° C. or lower, after being filled into the cartridge, in view of the storage stability of the ink. Accordingly, the syringe is more preferably made of polypropylene or polyethylene, which is a resin having a high cold resistance.

The plunger is preferably made of an elastic material since it slides along the inner wall of the syringe. Examples of the elastic material include: various types of rubber materials such as natural rubber, butyl rubber, isoprene rubber, butadiene rubber, styrene-butadiene rubber and silicone rubber; and thermoplastic elastomers such as polyethylene, polyurethane, polyester and polyamide.

The method of producing the ink-filled cartridge according to the present invention described above, will now be described. The ink to be filled into the cartridge contains various components, as will be described later, and the ink can be produced by blending and stirring the respective components at a predetermined blending ratio, using a known conventional method. In the present invention, in particular, the ink can be subjected to a vacuum stirring treatment. The vacuum stirring treatment enables the air bubbles to be removed, water, impurities having a low boiling point and the like, which have been incorporated during the stirring of the ink. The thus obtained ink has a viscosity at 25° C. of from 50 to 2,000 dPa·s, and the viscosity is preferably from 150 to 1,000 dPa·s, and more preferably from 300 to 600 dPa·s. In the case of an ink having a relatively low viscosity of less than 50 dPa·s, the air bubbles which have been inevitably mixed during the filling of the ink move upward over time without performing any special operation, by allowing the cartridge to stand such that the discharge nozzle faces downward. On the other hand, in the case of an ink having a high viscosity of more than 2,000 dPa·s, it is difficult to allow the air bubbles in the cartridge to be accumulated and localized so as to satisfy the relation: 0≤A/B<1.0. Above all, it is difficult to allow the air bubbles in the flange to be accumulated and localized so as to satisfy the relation: 0≤A′/B′<1.0. As will be described later, the viscosity of the ink can be adjusted by the type of the thermosetting resin and the content of the filler used, as well as an additive(s) to be optionally added and the like.

Subsequently, the thus adjusted ink is filled into the cartridge. The ink may be filled from the discharge nozzle 30 of the syringe 10 of the cartridge 1, or alternatively, the discharge nozzle 30 may be closed with the tip cap 50 in advance, and the ink may be filled from the opening 40 at the upper end of the syringe 10. In the case of filling the ink from the discharge nozzle 30, a method may be used in which the plunger 20 is slid to the side of the discharge nozzle 30 in advance, and the ink is filled from the discharge nozzle 30 by pressure filling so as to slide the plunger 20 upward (the state shown in the left side of FIG. 3), thereby completing the filling of the ink (the state shown in the right side of FIG. 3). It is of course possible to fill the ink into the syringe 10 at normal pressure in a state where the plunger is not attached, and attach the plunger 20 after the completion of the filling. Thereafter, the cartridge filled with the ink is sealed by closing the discharge nozzle 30 with the tip cap 50 and closing the opening 40 of the syringe 10 with the head cap 60.

As shown in FIG. 3, fine air bubbles (having a diameter of from about 1 to 5 mm) are uniformly contained in the ink, immediately after the ink has been filled into the cartridge as described above. In the case of an ink having a viscosity at 25° C. of from 50 to 2,000 dPa·s, such a very small amount of air bubbles cannot be moved upward (toward the side of the plunger in FIG. 3) only by gravity. In the present invention, fine air bubbles dispersed in the ink is accumulated to a predetermined position, and the air bubbles are localized so as to satisfy the relation: 0≤A/B<1.0, preferably satisfy the relation: 0≤A′/B′<1.0, by revolving, or rotating and revolving, the cartridge filled with the ink. From the viewpoint of the effect of the present invention, the cartridge is preferably rotated and revolved. In the case of rotating and revolving the cartridge, the rotation and revolution may be performed simultaneously or separately.

A rotation-revolution type centrifugal separator can be used, in order to break the air bubbles in the ink filled into the cartridge as well as to assemble small air bubbles to be formed into larger air bubbles having a certain size, and further, to move the air bubbles to the side of the plunger of the cartridge to be localized.

FIG. 7 is a schematic diagram illustrating the process of rotating and revolving the cartridge filled with the ink. The cartridge filled with the ink is revolved while being rotated. In this case, the cartridge is disposed such that the discharge nozzle side thereof faces downward (in the gravity direction) as shown in FIG. 7. The rotation axis of the cartridge may be set so as to be parallel (θ in the figure=0°) to the revolution axis. However, the cartridge is preferably revolved in an inclined state so that θ is within the range of from 30 to 60º. The inclination angle (θ) is 45°.

The speeds of rotation and revolution can be adjusted as appropriate depending on the viscosity of the ink. However, within the range of the viscosity (viscosity at 25° C. of from 50 to 2,000 dPa·s) of the ink to be used in the present invention, the rotation speed is preferably within the range of from 150 to 450 rpm, and more preferably within the range of from 250 to 350 rpm. Further, the revolution speed is preferably within the range of from 500 to 900 rpm, and more preferably within the range of from 650 to 850 rpm.

Next, the ink to be filled into the cartridge according to the present invention will be described. While any ink having a viscosity at 25° C. of from 50 to 2,000 dPa·s can be used in the cartridge according to the present invention, a filling ink used in a hole filling processing for a printed wiring board or the like, will be described as one example. The filling ink preferably contains at least a thermosetting resin, a curing agent and a filler. The respective components will be described below.

The thermosetting resin to be contained in the filling ink is not particularly limited, and any thermosetting resin can be used as long as the resin can be cured by heat. However, an epoxy resin can be suitably used. As the epoxy resin, any epoxy resin having two or more epoxy groups within one molecule can be used without particular limitation. Examples of the epoxy resin include epoxy resins having a bisphenol skeleton to be described later, phenol novolac type epoxy resins to be described later, cresol novolac type epoxy resins, bisphenol A novolac type epoxy resins, biphenyl type epoxy resins, naphthol type epoxy resins, naphthalene type epoxy resins, dicyclopentadiene type epoxy resins, triphenylmethane type epoxy resins, alicyclic epoxy resins, aliphatic linear epoxy resins, phosphorus-containing epoxy resins, anthracene type epoxy resins, norbornene type epoxy resins, adamantane type epoxy resins, fluorene type epoxy resins, aminophenol type epoxy resins to be described later, aminocresol type epoxy resins and alkylphenol type epoxy resins. The epoxy resins described above can be used singly, or in combination of two or more kinds thereof.

Further, the filling ink can contain an epoxy resin having a bisphenol skeleton. Examples of the epoxy resin having a bisphenol skeleton include bisphenol A type epoxy resins, bisphenol F type epoxy resins, bisphenol E (AD) type epoxy resins and bisphenol S type epoxy resins. Of these, a bisphenol A type epoxy resin, a bisphenol F type epoxy resin or a bisphenol E (AD) type epoxy resin is preferred. The epoxy resin having a bisphenol skeleton is used in the form of a liquid, a semi-solid or a solid. However, the epoxy resin is preferably in the form of a liquid from the viewpoint of filling ability. The resin “in the form of a liquid” herein means that the resin is in the state of a liquid having fluidity at 20° C. or 45° C.

These epoxy resins having a bisphenol skeleton may be used singly, or in combination of two or more kinds thereof. In particular, it is preferred to use a combination of two kinds of these resins, namely, a bisphenol A type epoxy resin and a bisphenol F type epoxy resin. Examples of commercially available products of these epoxy resins include: jER 828, jER 834 and jER 1001 (bisphenol A type epoxy resins), and jER 807 and jER 4004P (bisphenol F type epoxy resins), all of the above manufactured by Mitsubishi Chemical Corporation; and R710 (bisphenol E type epoxy resin) manufactured by AIR WATER Inc.

The filling ink may also contain a multifunctional epoxy resin. Examples of the multifunctional epoxy resin include: hydroxybenzophenone type epoxy resins such as EP-3300E manufactured by ADEKA Corporation; aminophenol type epoxy resins (para-aminophenol type liquid epoxy resin) such as jER 630 manufactured by Mitsubishi Chemical Corporation and ELM-100 manufactured by SUMITOMO CHEMICAL COMPANY, LIMITED; glycidyl amine type epoxy resins such as jER 604 manufactured by Mitsubishi Chemical Corporation, EPOTOTE YH-434 manufactured by NIPPON STEEL Chemical & Material Co., Ltd. and SUMI-EPOXY ELM-120 manufactured by SUMITOMO CHEMICAL COMPANY, LIMITED; and phenol novolac type epoxy resins such as DEN-431 manufactured by The Dow Chemical Company. These multifunctional epoxy resins can be used singly, or in combination of two or more kinds thereof.

In cases where the filling ink contains a thermosetting resin, the filling ink preferably contains a curing agent for curing the thermosetting resin. As the curing agent, a known curing agent commonly used for curing a thermosetting resin can be used. Examples of the curing agent include amines, imidazoles, multifunctional phenols, acid anhydrides and isocyanates, and polymers containing these functional groups. A plurality of these curing agents may be used, as necessary. Examples of the amines include dicyandiamide and diaminodiphenylmethane. Examples of the imidazoles include alkyl-substituted imidazoles and benzimidazole. Further, an imidazole compound may be an imidazole latent curing agent such as an imidazole adduct. Examples of the multifunctional phenols include hydroquinone, resorcinol and bisphenol A, and halogen compounds thereof, as well as novolac resins and resole resins which are condensation products of these with aldehydes. Examples of the acid anhydrides include phthalic anhydride, hexahydrophthalic anhydride, methylnadic anhydride and benzophenonetetracarboxylic acid. Examples of the isocyanates include tolylene diisocyanate and isophorone diisocyanate. One obtained by masking such an isocyanate with a phenol may also be used. These curing agents may be used singly, or in combination of two or more kinds thereof.

Among the curing agents described above, amines and imidazoles can be suitably used, from the viewpoints of the adhesion to conductive and insulating portions, the storage stability and the heat resistance. Preferred is a curing agent containing, as a main component: an adduct compound of an aliphatic polyamine, such as an alkylene diamine having from 2 to 6 carbon atoms, a polyalkylene polyamine having from 2 to 6 carbon atoms or an aromatic ring-containing aliphatic polyamine having from 8 to 15 carbon atoms; an adduct compound of an alicyclic polyamine such as isophoronediamine or 1,3-bis(aminomethyl)cyclohexane; or a mixture of the above-described adduct compound of an aliphatic polyamine and the above-described adduct compound of an alicyclic polyamine. In particular, a curing agent containing an adduct compound of xylylenediamine or isophoronediamine, as a main component, is preferred.

The above-described adduct compound of an aliphatic polyamine is preferably one obtained by the addition reaction of the aliphatic polyamine with an aryl glycidyl ether (particularly, phenyl glycidyl ether or tolyl glycidyl ether) or with an alkyl glycidyl ether. Further, the above-described adduct compound of an alicyclic polyamine is preferably one obtained by the addition reaction of the alicyclic polyamine with n-butyl glycidyl ether, bisphenol A diglycidyl ether or the like.

Examples of the aliphatic polyamine include: alkylene diamines having from 2 to 6 carbon atoms, such as ethylenediamine and propylenediamine; polyalkylene polyamines having from 2 to 6 carbon atoms, such as diethylenetriamine and triethylenetriamine; and aromatic ring-containing aliphatic polyamines having from 8 to 15 carbon atoms, such as xylylenediamine. Examples of commercially available products of modified aliphatic polyamines include: FXR-1020, Fujicure FXR-1030 and Fujicure FXR-1080 (manufactured by T&K TOKA Corporation); and Ancamine 2089 K, Sunmide P-117, Sunmide X-4150, Ancamine 2422, Thurwet R and Sunmide A-100 (manufactured by Evonik Japan Co., Ltd.).

Examples of the alicyclic polyamine include isophoronediamine, 1,3-bis(aminomethyl)cyclohexane, bis(4-aminocyclohexyl)methane, norbornenediamine, 1,2-diaminocyclohexane and Laromin. Examples of commercially available products of modified alicyclic polyamines include: Ancamine 1693, Ancamine 2074, Ancamine 2596, Ancamine 2199, Sunmide IM-544, Sunmide I-544, Ancamine 2075, Ancamine 2280 and Ancamine 2228 (manufactured by Evonik Japan Co., Ltd.); DAITOCURAR F-5197 and DAITOCURAR B-1616 (manufactured by Daito Industry Co., Ltd.); Fujicure FXD-821-F (manufactured by T&K TOKA Corporation); jERcure 113 (manufactured by Mitsubishi Chemical Corporation); and Laromin C-260 (manufactured by BASF JAPAN Ltd.). In addition, examples of a polyamine type curing agent include EH-5015S (manufactured by ADEKA Corporation).

Among the curing agents described above, it is preferred that the filling ink contain at least two or more kinds of the above-described curing agents and one of them be an imidazole, from the viewpoint of the ability to maintain the storage stability of the filling ink. An imidazole refers, for example, to a reaction product of an epoxy resin with imidazole. Examples thereof include 2-methylimidazole, 4-methyl-2-ethylimidazole, 2-phenylimidazole, 4-methyl-2-phenylimidazole, 1-benzyl-2-methylimidazole, 2-ethylimidazole, 2-isopropylimidazole, 1-cyanoethyl-2-methylimidazole, 1-cyanoethyl-2-ethyl-4-methylimidazole and 1-cyanoethyl-2-undecylimidazole. Examples of commercially available products of the imidazole compound include: imidazoles such as 2E4MZ, C11Z, C17Z and 2PZ; AZINE compounds of imidazole, such as 2MZ-A and 2E4MZ-A; isocyanuric acid salts of imidazole, such as 2MZ-OK and 2PZ-OK; hydroxymethyl forms of imidazole, such as 2PHZ and 2P4MHZ (all of these manufactured by SHIKOKU CHEMICALS CORPORATION). Examples of commercially available products of the imidazole latent curing agent include CUREDUCT P-0505 (manufactured by SHIKOKU CHEMICALS CORPORATION). Further, the curing agent to be used in combination with an imidazole is preferably a modified aliphatic polyamine, a polyamine curing agent, an imidazole latent curing agent.

The amount of the curing agent to be blended when the ink contains a thermosetting resin is preferably from 0.1 to 30 parts by mass and more preferably from 1 to 20 parts by mass with respect to 100 parts by mass of the thermosetting resin, in terms of solid content, from the viewpoints of properties such as the storage stability and the curing rate of a curable resin composition, and the heat resistance and the adhesion of a cured product of the curable resin composition. Further, in the case of using an imidazole and a curing agent other than that, in combination, the blending ratio of the imidazole and the other curing agent is preferably from 1:99 to 99:1, and more preferably from 10:90 to 90:10, based on mass.

The filling ink is used as a hole-filling filler for filling an open hole such as a through hole, or a recess, in a printed wiring board, and preferably contains an inorganic filler for relaxing the stress due to curing shrinkage or adjusting the linear expansion coefficient, of the filler. A known inorganic filler used for an ordinary resin composition can be used as the inorganic filler. Specific examples of the inorganic filler include: non-metallic fillers such as silica, barium sulfate, calcium carbonate, silicon nitride, aluminum nitride, boron nitride, alumina, magnesium oxide, aluminum hydroxide, magnesium hydroxide, titanium oxide, mica, talc, clay, kaolin and organic bentonite; and metallic fillers such as copper, gold, silver, palladium and silicone. These inorganic fillers may be used singly, or in combination of two or more kinds thereof.

Among these inorganic fillers, silica, calcium carbonate, barium sulfate and aluminum oxide which have an excellent low hygroscopicity and low volume expansion are suitably used. In particular, silica and calcium carbonate are more suitably used. The silica may be either an amorphous silica or a crystalline silica, and may also be a mixture of these. In particular, an amorphous (fused) silica is preferred. Further, calcium carbonate may be either a natural heavy calcium carbonate or a synthesized precipitated calcium carbonate.

The shape of the inorganic filler is not particularly limited, and the inorganic filler may have, for example, a spherical shape, a needle-like shape, a plate-like shape, a scaly shape, a hollow shape, an amorphous shape, a hexagonal shape, a cubic shape or a flaky shape. However, the inorganic filler preferably has a spherical shape, from the viewpoint that the filler can be blended at a high ratio.

Further, such an inorganic filler has an average particle size within the range of from 0.1 μm to 25 μm, preferably from 0.1 μm to 15 μm, in view of the dispersibility of the inorganic filler, the filling ability into a hole, the smoothness when a wiring layer is formed on the filled portion of the hole. The inorganic filler more preferably has an average particle size of from 1 μm to 10 μm. The “average particle size” refers to the average primary particle size, and the average particle size (D50) can be measured by a laser diffraction/scattering method.

The blending ratio of the inorganic filler when the ink contains a thermosetting resin is preferably from 10 to 1,000 parts by mass, more preferably from 20 to 500 parts by mass and particularly preferably from 30 to 400 parts by mass with respect to 100 parts by mass of the thermosetting resin, in terms of solid content, from the viewpoint of achieving both a good thermal expansion coefficient, polishability and adhesion, when formed into a cured product, as well as printability and hole-filling ability, in a balanced manner.

A filler treated with a fatty acid in order to impart thixotropy, or an amorphous filler such as an organic bentonite or talc can be added to the filling ink.

As the fatty acid described above, it is possible to use a compound represented by the general formula (R1COO)ₙ—R2 (wherein the substituent R1 represents a hydrocarbon having 5 or more carbon atoms; the substituent R2 represents a hydrogen, a metal alkoxide or a metal; and n represents a number from 1 to 4). The fatty acid can exhibit the effect of imparting thixotropy, when the substituent R1 has 5 or more carbon atoms. n is more preferably 7 or more.

The fatty acid may be an unsaturated fatty acid having a double bond or a triple bond in the carbon chain, or may be a saturated fatty acid which does not have such a bond. Examples the fatty acid include stearic acid (18:0; these figures represent the number of carbon atoms and the number of unsaturated bonds; the figure in further parentheses is the numerical value representing the position thereof), hexanoic acid (6:0), oleic acid (18:1(9)), icosanoic acid (20:0), docosanoic acid (22:0) and melissic acid (30:0). The substituent R1 in such a fatty acid preferably has from 5 to 30 carbon atoms. The substituent R1 more preferably has from 5 to 20 carbon atoms. Alternatively, the fatty acid may be, for example, one having a skeleton with a coupling agent-based structure and a long aliphatic chain (having 5 or more carbon atoms), such as a metal alkoxide in which the substituent R2 is a titanate-based substituent capped with an alkoxyl group. For example, it is possible to use KR-TTS (trade name; manufactured by Ajinomoto Fine Techno Co., Ltd.) or the like. In addition, a metal soap such as aluminum stearate or barium stearate (each manufactured by Kawamura Kasei Industry Co., Ltd.) can be used. Examples of other metal soap elements include Ca, Zn, Li, Mg and Na.

An appropriate blending ratio of the fatty acid when the ink contains an inorganic filler is from 0.1 to 2 parts by mass with respect to 100 parts by mass of the inorganic filler, from the viewpoints of the thixotropy, embeddability, antifoaming properties and the like.

The fatty acid may be blended by using an inorganic filler surface-treated with the fatty acid in advance. This allows for more effectively imparting thixotropy to the resulting filling ink. In this case, the blending ratio of the fatty acid can be reduced as compared to the case of using an untreated filler. When the ink contains an inorganic filler(s), and in cases where all the inorganic filler(s) is/are a filler(s) treated with a fatty acid, the blending ratio of the fatty acid(s) is preferably from 0.1 to 1 part by mass with respect to 100 parts by mass of the inorganic filler.

Further, the filling ink may contain a silane-based coupling agent. By blending a silane-based coupling agent, it becomes possible to improve the adhesion between the inorganic filler and the epoxy resin, and to prevent the occurrence of cracks in the resulting cured product.

Examples of the silane-based coupling agent include epoxysilanes, vinylsilanes, imidazolesilanes, mercaptosilanes, methacryloxysilanes, aminosilanes, styrylsilanes, isocyanatesilanes, sulfidesilanes and ureidosilanes. Further, the silane-based coupling agent may be blended by using an inorganic filler surface-treated with the silane-based coupling agent in advance.

The blending ratio of the silane-based coupling agent when the ink contains an inorganic filler is preferably from 0.05 to 2.5 parts by mass with respect to 100 parts by mass of the inorganic filler, from the viewpoint of achieving both the adhesion between the inorganic filler and the epoxy resin as well as antifoaming properties, in a balanced manner.

In addition, the filling ink may contain, if necessary, an oxazine compound having an oxazine ring, obtained by the reaction of a phenol compound, formalin and a primary amine. When the filling ink filled into holes in a printed wiring board is cured and then electroless plating is performed on the thus formed cured product, the incorporation of the oxazine compound to the ink facilitates the roughening of the cured product with an aqueous solution of potassium permanganate or the like, and enables the peel strength with the plating to improve.

A known colorant used in an ordinary resist ink for screen printing, such as phthalocyanine blue, phthalocyanine green, disazo yellow, carbon black or naphthalene black may also be added to the filling ink.

It is also possible to add to the filling ink a known thermal polymerization inhibitor for imparting storage stability during the storage, such as hydroquinone, hydroquinone monomethyl ether, tert-butylcatechol, pyrogallol or phenothiazine, a known thickener for adjusting the viscosity and the like, such as montmorillonite, and/or a thixotropic agent. In addition, the filling ink may contain a known additive, such as, for example, a silicone-based, fluorine-based or polymer-based antifoaming agent or leveling agent, an adhesion-imparting agent such as a thiazole-based or triazole-based silane coupling agent, or the like. In particular, the use of an organic bentonite is preferred, because the filled portions overflown from the hole surfaces tend to be formed in a protruding state which can be more easily polished and removed, thereby providing an excellent polishability.

The filling ink can be used in various applications without particular limitation. In particular, the ink can be used as a solder resist, an interlayer insulating material, a marking ink, a coverlay or a solder dam in a printed wiring board, or as a filler for filling an open hole such as a through hole or a via hole, or a recessed hole, in a printed wiring board. Among these, the filling ink is suitable as a filling ink for filling an open hole such as a through hole or a via hole, or a recessed hole, in a printed wiring board. In the case of using the ink-filled cartridge according to the present invention, in particular, dripping or bleeding is less likely to occur even in cases where the ink is used for filling a hole in a printed wiring board having a hole with a large opening diameter. Above all, the occurrence of cracks can be reduced, because the mixing of air bubbles does not occur even in cases where the ink is used for filling a hole in a multilayer printed wiring board including a conductive portion and an insulating portion on the inner wall of a hole, such as a through hole.

After filling the ink as described above into the cartridge, the thus filled ink cartridge is preferably stored at a temperature in which the ink reaches 10° C. or lower, and more preferably stored frozen in state of −40° C. or higher and 0° C. or lower. Such an arrangement enables the reaction of the ink to reduce during the storage of the ink-filled cartridge, and to increase the storage stability.

The ink-filled cartridge according to the present invention is used by setting the cartridge to a dedicated printing apparatus (for example, THP35, manufactured by I.T.C. Intercircuit Electronic GmbH), and discharging a specified amount of ink from the discharge nozzle of the cartridge. Although the ink-filled cartridge is preferably stored at a temperature in which the ink reaches 10° C. or lower, as described above, the cartridge is preferably left to stand until the temperature of the ink reaches room temperature, before use. At the time of using the cartridge in a room temperature environment, the cartridge is preferably maintained such that the discharge nozzle side thereof faces downward and the plunger side thereof faces upward, until the temperature of the ink reaches room temperature from 10° C. or lower.

### EXAMPLES

Next, the present invention will be described in further detail with reference to Examples. However, the present invention is in no way limited to these Examples. In the following description, the terms “part(s)” and “%” are based on mass unless otherwise specified.

### <Preparation of Ink>

Various types of components shown in the following Table 1 are blended at the respective ratios (parts by mass) shown in the Table, and mixed with a stirrer, to prepare the inks of Examples 1 to 4 and Comparative Examples 1 to 5. The details of the respective components shown in Table 1 are as follows.
*1: Bisphenol A type epoxy resin (EP-4100HF, manufactured by ADEKA Corporation)
*2: Glycidyl amine type epoxy resin (EP-3950S, manufactured by ADEKA Corporation)
*3: Glycidyl amine-based epoxy resin (GOT, manufactured by Nippon Kayaku Co., Ltd.)
*4: Imidazole-based curing agent (CUREZOL 2MZA-PW, manufactured by Shikoku Chemicals Corporation)
*5: Calcium carbonate (SOFTON 1800, manufactured by Bihoku Funka Kogyo Co., Ltd.)
*6: Amorphous silica (SO-C6, manufactured by Admatechs Company Limited)
*7: Fumed silica (AEROSIL R972, manufactured by NIPPON AEROSIL CO., LTD.)
   <Filling of Ink into Ink Cartridge>

Each of the inks obtained as described above was subjected to a stirring treatment for 120 minutes, using a vacuum stirring apparatus. Subsequently, each ink subjected to the vacuum stirring treatment was filled into a cartridge as shown in FIG. 1 that includes a cylindrical syringe having a discharge nozzle on one end and having an opening on the other end, and a plunger configured to slide from the opening of the syringe to define the filling capacity within the syringe, from the discharge nozzle of the cartridge. The ink was filled until the ink overflowed from the discharge nozzle, and the discharge nozzle was closed by attaching a tip cap thereto. In the cartridge of Comparative Example 5, the ink was filled without being subjected to the vacuum stirring treatment.

The cartridges each filled with each ink were centrifuged under the conditions shown in Table 1, using a rotation-revolution type apparatus. However, the cartridges of Example 2 and Comparative Example 1 were not centrifuged.

### <Evaluation of Degree of Mixing of Air Bubbles>

The volume of air bubbles contained in the ink filled in each cartridge was determined by 3D-scanning the syringe at a scanning resolution of 0.083 mm, using an X-ray industrial computed tomography apparatus (NAOMi-CT-3D-L, manufactured by RF Co., Ltd.). Thereafter, while observing the vertical cross sections of the resulting 3D scanned image relative to the axial direction of the cylindrical syringe, continuously in the axial direction, the number of the respective air bubbles observed was counted, and the air bubble volume (V) was calculated from the measured maximum diameter R of each air bubble, by the following Formula:

V=(πR³)/6

(wherein V represents the air bubble volume, and R represents the maximum diameter of air bubble).

Subsequently, the total volume of air bubbles in the ink filled in each syringe was calculated by summing the volume of each air bubble calculated as described above. Each calculated value is shown in Table 1. The numerical values of the volume of air bubbles shown in Table 1 are values truncated to two decimal places.

In the same manner, the volume of air bubbles was calculated for each of the discharge nozzle-side and the plunger-side portions. The smallest air bubble that could be observed in the scanned image had a diameter of 0.2 mm.

Taking a point in the middle of the distance from the lower end of the discharge nozzle to the plunger as the midpoint (L/2), the number (An) of air bubbles present in the portion of the syringe from the discharge nozzle to the midpoint and the total volume (A) of air bubbles present therein, as well as the number (Bn) of air bubbles present in the portion of the syringe from the midpoint to the plunger and the total volume (B) of air bubbles present therein, were calculated, as described above.

Further, taking the distance from the lower end of the discharge nozzle to the plunger as L, the number (A′n) of air bubbles present in the portion of the syringe from the lower end of the discharge nozzle to a point at a distance of 0.9 L therefrom and the total volume (A′) of air bubbles present therein, as well as the number (B′n) of air bubbles present in the portion of the syringe from the point at a distance of 0.9 L to the plunger and the total volume (B′) of air bubbles present therein, were calculated. When the diameter of each air bubble (A′R or B′R) was measured at the time of counting the number (A′n or B′n) of the air bubbles, the mean value of A′R was about 0.5 mm, and the mean value of B′R was about 0.6 mm.

The numbers of air bubbles and the total volumes of air bubbles in each cartridge were as shown in Table 1.

### <Evaluation of Air Bubbles in Ink>

Each ink-filled cartridge described above was stored at −20° C. for seven days. Thereafter, the cartridge was placed such that the discharge nozzle side thereof faced downward and the plunger side thereof faced upward, and thawed over 6 hours until the temperature of the filled ink reached room temperature (23±1° C.).

Subsequently, the plunger of the cartridge was slid to discharge the ink from the discharge nozzle on the surface of a transparent polyester film. The plunger was slid until the ink was no longer discharged. Due to the structure of the cartridge, the amount of the discharged ink was about 90 percent of the entire ink filled in the syringe.

The ink discharged on the PET film was visually observed, and the number of air bubbles contained in the ink was counted. The degree of mixing of air bubbles was evaluated based on the number of air bubbles. The evaluation criteria were as follows.
Good: 0
Acceptable: from 1 to 3
Poor: 4 or more

The evaluation results were as shown in Table 1.

### <Evaluation of Voids and Cracks>

Using a dedicated hole-filling printing apparatus (THP35, manufactured by I.T.C. Intercircuit Electronic GmbH) for a cartridge, each ink was filled into the through holes of a glass epoxy substrate (a glass epoxy substrate having through holes in which conductive layers are formed by panel plating, and having a thickness of 1.6 mm, a through hole diameter of 0.35 mm (after plating) and a pitch of 1 mm), from each ink-filled cartridge.

After the completion of filling the ink into the through holes, each substrate was heated in a hot air circulation drying furnace at 110° C. for 60 minutes, followed by heating at 150° C. for 60 minutes, to cure the ink, thereby obtaining each evaluation substrate.

The thus obtained evaluation substrate was cut with a precision cutter such that the substrate was cut at a cross section passing through the centers of the through holes. After polishing the cross section, the surface condition of the cross section was observed with a light microscope. The observation was performed for 100 through holes, and the number of voids and cracks was counted. The evaluation criteria were as follows.
Excellent: 0
Good: from 1 to 5
Acceptable: from 6 to 10
Poor:11 or more

The evaluation results were as shown in Table 1.

TABLE 1

| | | Example | | | | Comparative Example | | | | |
|---|---|---|---|---|---|---|---|---|---|---|
| | | 1 | 2 | 3 | 4 | 1 | 2 | 3 | 4 | 5 |
| Ink | EP-4100HF | 80 | 30 | 80 | 80 | 80 | 80 | 100 | 80 | 80 |
| composition | EP-3950 S | 20 | 20 | 20 | 20 | 20 | 20 | — | 20 | 20 |
| | GOT | — | — | — | 4 | — | — | — | — | — |
| | 2MZA-PW | 6 | 6 | 6 | 6 | 6 | 6 | 6 | 6 | 6 |
| | SOFTON 1800 | 120 | 50 | 30 | 10 | 20 | 20 | 150 | | 120 |
| | SO-C6 | — | — | 150 | 150 | 100 | 100 | — | — | — |
| | AEROSIL R972 | — | — | — | — | — | — | — | 3 | — |
| Ink viscosity (dPa · s) | | 450 | 120 | 1250 | 500 | 450 | 450 | 2200 | 35 | 450 |
| Production | Vacuum stirring | 120 | 120 | 120 | 120 | 120 | 120 | 120 | 120 | — |
| Process | treatment time | | | | | | | | | |
| | (minutes) | | | | | | | | | |
| | Rotation-revolution | 5 | — | 5 | 5 | — | 5 | 5 | 5 | 10 |
| | treatment time | | | | | | | | | |
| | (minutes) | | | | | | | | | |
| | Number of rotation/ | 300/700 | — | 300/700 | 300/700 | — | 100/1000 | 300/700 | 300/700 | 300/700 |
| | number of revolution | | | | | | | | | |
| | (rpm) | | | | | | | | | |
| Number of | Bn | 3 | 4 | 5 | 4 | 3 | 2 | 6 | 3 | 16 |
| air bubbles | An | 0 | 1 | 2 | 0 | 10 | 5 | 12 | 6 | 35 |
| | B′n | 3 | 4 | 5 | 3 | 3 | 2 | 3 | 3 | 6 |
| | A′n | 0 | 1 | 2 | 1 | 10 | 5 | 15 | 6 | 45 |
| Volume of | B (10⁻⁴ cm³) | 3.3 | 4.5 | 5.6 | 4.5 | 3.3 | 2.3 | 6.7 | 3.3 | 18.1 |
| air bubbles | A (10⁻⁴ cm³) | 0.0 | 0.6 | 1.3 | 0.0 | 6.5 | 3.2 | 7.8 | 3.9 | 22.9 |
| | B′ (10⁻⁴ cm³)) | 3.3 | 4.5 | 5.7 | 3.4 | 3.4 | 2.3 | 3.4 | 3.4 | 6.7 |
| | A′ (10⁻⁴ cm³) | 0.0 | 0.7 | 1.3 | 0.7 | 6.5 | 3.2 | 9.8 | 3.9 | 29.4 |
| | A/B | 0.0 | 0.1 | 0.2 | 0.0 | 1.9 | 1.3 | 1.1 | 1.1 | 1.2 |
| | A′/B′ | 0.0 | 0.1 | 0.2 | 0.2 | 1.9 | 1.3 | 2.8 | 1.1 | 4.3 |

| | | | | | | | | | |
|---|---|---|---|---|---|---|---|---|---|
| Evaluation of air bubbles in ink | Excellent | Excellent | Excellent | Excellent | Poor | Acceptable | Poor | Poor | Poor |
| Evaluation of voids and cracks | Excellent | Good | Excellent | Excellent | Poor | Poor | Poor | Poor | Poor |

As is evident from Table 1, in each of the ink cartridges (Examples 1 to 4) filled with an ink having a viscosity within the range of from 50 to 2,000 dPa·s, in which the ratio A/B is within the range of 0≤A/B<1.0, it can be seen that the amount of air bubbles in the ink which has been discharged from the cartridge is small, and voids and cracks do not occur even when used for filling of holes such as through holes.

In contrast, in each of the ink cartridges (Comparative Examples 1 to 5) in which the ratio A/B satisfies A/B≤1.0, it can be seen that air bubbles are contained in the ink which has been discharged from the cartridge, and voids and cracks occur when used for filling of holes such as through holes.

### DESCRIPTION OF SYMBOLS

1: Ink-Filled Cartridge
2: Cartridge
3: Ink
10: Syringe
20: Plunger
30: Discharge Nozzle
40: Opening
50: Tip Cap
60: Head Cap
70: Air Bubble

1. An ink-filled cartridge comprising,
a cartridge comprising:
a cylindrical syringe having a discharge nozzle on one end and having an opening on the other end; and
a plunger configured to slide from the opening of the syringe to define the filling capacity within the syringe; and
an ink filled in a defined space within the syringe of the cartridge;
wherein:
the ink has a viscosity at 25° C. of from 50 to 2,000 dPa·s, as measured in accordance with “10. Viscosity Measurement Method Using Cone-plate Rotational Viscometer” specified in JIS K 8803: 2011, using a cone-plate viscometer at 25° C. and 5 rpm for 30 seconds;
the ink in the syringe contains one or more air bubbles having a diameter of 0.1 mm or more; and
when a distance from a lower end of the discharge nozzle to the plunger, in a cylindrical axis direction of the syringe, is defined as L, and when the lower end of the discharge nozzle is defined as a starting point (S), a point at a distance of L/2 therefrom is defined as a point (M) and the plunger is defined as an end point (F), a total volume A (cm³) of air bubbles in a portion of the syringe corresponding to a distance from the starting point (S) to the point (M), and a total volume B (cm³) of air bubbles in a portion of the syringe corresponding to a distance from the point (M) to the end point (F), satisfy the following relation:
0≤A/B<1.0.

2. The ink-filled cartridge according to claim 1, wherein a total volume A′ (cm³) of air bubbles in a portion of the syringe corresponding to the distance from the starting point (S) to a point (M′) at a distance of 0.9 L therefrom, in the cylindrical axis direction of the syringe, and a total volume B′ (cm³) of air bubbles in a portion of the syringe corresponding to the distance from the point (M′) to the end point (F), in the cylindrical axis direction, satisfy the following relation:
0≤A′/B′<1.0.

3. The ink-filled cartridge according to claim 2, wherein the air bubbles present in the portion of the syringe corresponding to the distance from the starting point (S) to the point (M′) have a diameter of from 0.1 to 0.3 mm.

4. The ink-filled cartridge according to claim 1, wherein, when a volume of the ink filled in the portion of the syringe corresponding to the distance from the point (M) to the end point (F) is defined as C (cm³), a ratio of the total volume B of air bubbles with respect to the volume C of the ink satisfies the following relation:
0≤B/C≤1.0×10⁻¹.

5. The ink-filled cartridge according to claim 1, wherein the ink-filled cartridge is stored in an environment in which the temperature of the filled ink reaches 10° C. or lower.

6. The ink-filled cartridge according to claim 1, wherein the ink comprises at least a thermosetting resin, a curing agent, and a filler.

7. The ink-filled cartridge according to claim 1, wherein the ink is a filling ink for filling a hole in a printed wiring board.

8. The ink-filled cartridge according to claim 1, wherein the ink-filled cartridge comprises a tip cap on the upper end of the discharge nozzle.

9. A method of using the ink-filled cartridge according to claim 1, the method comprising, at the time of using the ink-filled cartridge which has been stored in an environment of 10° C. or lower in a room temperature environment, maintaining the cartridge such that a discharge nozzle side thereof faces downward and a plunger side thereof faces upward, until a temperature of the ink reaches room temperature from 10° C. or lower.
